(19) United States
(12) Patent Application Publication
(10) Pub. No.: US 2019/0054752 A1
(43) Pub. Date: Feb. 21, 2019

(54) NOTEBOOK AND MANUFACTURING METHOD THEREFOR

(71) Applicant: YUGENGAISHA MISATOMIRA121, Taito-ku (JP)

(72) Inventor: Manabu FUKUDA, Misato (JP)

(73) Assignee: YUGENGAISHA MISATOMIRA121, Taito-ku (JP)

(21) Appl. No.: 15/770,530

(22) PCT Filed: Oct. 25, 2016
(86) PCT No.: PCT/JP2016/081536

§ 371 Date: Apr. 24, 2018

(30) Foreign Application Priority Data
Oct. 26, 2015 (JP) 2015-209830

(51) Int. Cl. B42C 19/06; B42C 9/02; B42C 11/00; B42D 1/04; B42D 15/00

(52) U.S. Cl. CPC B42C 19/06; B42C 9/02; B42D 15/0006; B42D 1/04; B42C 11/00

(57) ABSTRACT

A notebook is formed by folding up zigzag a continuous web form for every unit form with rouletted fold lines to form a text unit including a preset number of unit forms. After cutting off one folded side to leave the other folded side, the text unit is sandwiched between a front cover and a back cover and is covered with a spine. The spine is pressed against the remaining the other folded side of the text unit together with the front cover and the back cover by the medium of a mesh cloth impregnated with an adhesive so as to cover and wrap the whole a back of the stack of the front cover, the text unit and the back cover. The notebook can be used in a completely spread state (180-degree horizontal state) and conveniently, and retains high security and high functionality. A process for producing the notebook.

### TECHNICAL FIELD

The present invention relates to a notebook of which all the pages can be fully spread and which has a high quality, high security and functionality, and a production process for the same.

### BACKGROUND ART

The present inventor developed a fundamental printing technology of using an endless belt-shaped printing plate for manufacturing an elongated strip-shaped printed continuous form by printing on an elongated continuous web form (continuous paper web). The technology of printing on a continuous form using an endless belt-shaped printing plate is applied to preparation of booklet forms for payment of a pension and insurance or a tax, a calendar, a contract, an operation manual, books, and notebooks, etc.

A notebook has been conventionally prepared by covering a plurality, e.g., 40 or 60, of inside paper sheets, with a front cover and a back cover, and by fixing or gluing the sides of the sheets to form a booklet. The inside paper sheets of a notebook are formed by printing ruled lines on each face of paper sheet. Although the ruled lines are formed as solid lines or dotted lines, the inside paper sheets of a notebook are formed of separate sheets.

A conventional type of notebook has been formed by folding a group of e.g. 10 double-side-printed sheets in folio and stacking and binding plural, e.g. two, folded groups of sheets to form a text unit, followed by covering a back of the text unit with a cover sheet forming a front cover and a back cover together with an adhesive and then wrapping thereon with a reinforcing cloth paper, for sale.

### PRIOR ART DOCUMENTS

### Patent Documents

[Patent document 1] JP 2015-66947 A

[Patent document 2] JP 5324950 B

[Patent document 3] JP 5389769 B

[Patent document 4] JP 5225237 B

### SUMMARY OF THE INVENTION

### Problems to be Solved by the Invention

In a type of conventional notebook in a booklet form, inside paper sheets covered with a front cover and a back cover are laminated and bound with each other with an adhesive on a backside end face thereof. In this type of notebook, even if some inside papers are missing or fallen off, it has been difficult to notice such failure of falling-off of inside paper sheets.

On the other hand, the type of notebook prepared by including folios of superposed and folded paper sheets involves a difficulty in obtaining a complete spread state (180-degree horizontal state) for recording or writing therein because of traces of the folding, thus lacking in freedom or convenience of use.

Furthermore, the printing technology by a copying machine is developed in recent years and, in connection therewith, it is desired to develop a high-security print of which reproduction is impossible with a copying machine. Similarly, it is also expected to develop a notebook of which reproduction of contents such as characters is difficult.

The present invention has been made in consideration of the situation mentioned above, and an object of the present invention is to provide a notebook which can be used in a complete spread state (180-degree horizontal state) and conveniently, and retains high security and high functionality, and also a process for producing the notebook.

### Means for Solving the Problems

The present invention relates to a notebook which has been provided in order to solve the above-mentioned problems and is produced by: folding up zigzag a continuous web form which has on both surfaces thereof a multiplicity of printed successive unit forms and is provided with an intermediate rouletted fold line formed between each pair of the successive unit forms in a width direction of the continuous web form, for every unit form with rouletted fold lines; cutting and separating the continuous web form for every preset number of successive unit forms in a form width direction to form a text unit; cutting off at least one side including one folded side while leaving the other folded side of the text unit, thereby forming a text unit comprising a stack of multiplicity of sheet pairs; sandwiching the text unit with a front cover and a back cover; and covering and wrapping a side including said remaining the other folded side of the text book of the resultant stack of the front cover, the text unit and the back cover with a spine by medium of a mesh cloth impregnated with an adhesive, to form an integrated notebook.

The present invention also relates to a notebook which has been provided in order to solve the above-mentioned problems and is produced by: folding up zigzag a continuous web form for every unit form with rouletted fold lines formed in a form width direction; cutting and separating the continuous web form for every preset number of successive unit forms in a form width direction to form a text unit; cutting off three sides including one folded side while leaving the other folded side of the text unit; applying and pressing an adhesive and a mesh cloth onto an outer side including the other folded side of the text unit; and disposing a front cover, a spine and a back cover so as to wrap the text unit, thereby providing an integrated notebook.

The present invention further relates to a notebook which has been provided in order to solve the above-mentioned problems and is produced by: stacking a multiplicity of sheet pairs each comprising a pair of unit forms connected and folded with each other via a rouletted fold line to form a group of stacked unit forms; pressing an adhesive and a mesh cloth against a back folded side of the unit form group for adhesion; and disposing a front cover, a spine and a back cover so as to wrap the unit form group, thereby providing an integrated notebook.

The present invention further relates to a process for producing a notebook, which has been provided in order to solve the above-mentioned problems and comprises: rouletting a continuous web form having on both surfaces thereof a multiplicity of printed unit forms to form rouletted fold lines in a width direction of the continuous web form; folding up zigzag the continuous web form along the rouletted fold lines, and cutting and separating the continuous web form for every preset number of successive unit forms in a form width direction, to form a text unit; sandwiching the zigzag-folded text unit with a front cover and a back cover, and pressing a mesh cloth impregnated with an adhesive against a back side of a resultant stack of the front cover, the text unit and the back cover, for integration; disposing a binding cloth as a spine so as to wrap a back side of the integrated structure; and cutting off one folded side leaving the other folded side of the text unit before or after the disposition of the binding cloth.

The present invention further relates to a process for producing a notebook, which has been provided in order to solve the above-mentioned problems and comprises: rouletting a continuous web form to form rouletted fold lines in a width direction of the continuous web form; folding up zigzag the continuous web form along the rouletted fold lines, and cutting and separating the continuous web form for every preset number of successive unit forms in a form width direction, to form a text unit; applying an adhesive and a mesh cloth onto an outer side of one folded side of the text unit comprising the unit form group, and applying thereover a front cover, a spine and a back cover onto said one folded side of the text unit; and cutting off three sides including the other folded side while leaving said one folded side of the text nit, after the formation of the text unit or after unit further wrapping the text unit with the front cover, text unit and back cover.

### Effect of the Invention

In the notebook of the invention, the back of the text unit is bonded to the spine via an adhesive and a mesh cloth to be integrated, an adhesive strength between each pair of zigzag-folded unit forms is enhanced because of an adhesive penetrated through the rouletted fold line, and the neighboring unit forms can be spread in a completely spread state (horizontal state) because they are integrally connected via fold lines, thus proving an improved usability including easiness of copying by using a copying machine.

Further, the unit form may have a form face including a main data area equipped at least with a horizontal ruled line printed with micro characters, which are collapsed when copied by a copying machine, thus preventing fraudulent reproduction, so that the notebook may have high quality, excellent security and functionality.

### BRIEF DESCRIPTION OF THE DRAWINGS

FIG. 1 A configuration diagram for illustrating an operation principle of an embodiment of notebook manufacturing apparatus.

FIG. 2 A plan view showing a printed state of an intermediate part of a continuous web form produced by the above-mentioned notebook manufacturing apparatus.

FIG. 3 A perspective view showing a form inverter device installed at an intermediate position in the above-mentioned apparatus.

FIG. 4 A perspective view illustrating a text unit formed of a preset number of unit forms.

FIG. 5 A plan view showing a form face of each unit form which constitutes the above-mentioned notebook.

FIG. 6 A sketch illustrating a process for making the notebook by superposing a front cover and a back cover onto the text unit of the zigzag-folded unit form group to bind them together.

FIG. 7 A partial sectional view taken along a VII-VII line in FIG. 5.

FIG. 8 An enlarged view of an A section of FIG. 7.

FIG. 9 A plan view illustrating a unit form face having thereon a printed table-of-contents (CONTENTS) part of the notebook.

FIG. 10 An illustration of a unit form face showing a printed data area among the unit form group which constitutes the text unit of a notebook.

FIG. 11A and FIG. 11B are partial views showing enlarged views of a B section and a C section, respectively, in FIG. 5.

FIG. 12 A configuration diagram illustrating a notebook manufacturing apparatus for producing a color-printed notebook according to a second embodiment of the invention.

FIG. 13 An illustration of a notebook according to the invention to be used as a conference record note.

### EMBODIMENTS OF THE INVENTION

Hereinafter, the present invention will be described based on embodiments thereof with reference to accompanying drawings.

### First Embodiment

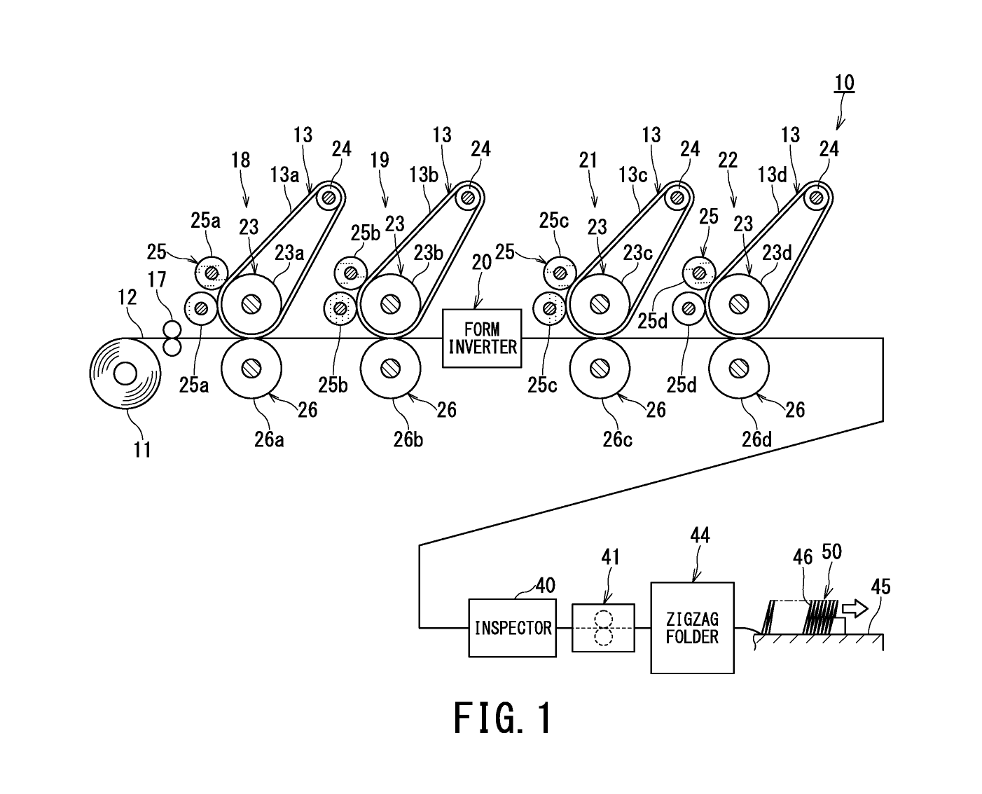

FIG. 1 is a configuration diagram for illustrating an operation principle of an embodiment of notebook manufacturing apparatus, whereby an elongated continuous web form (continuous paper) is successively printed on both surfaces thereof by means of a plurality of printers, that is, at least two printers, each equipped with an elongated, flexible, endless belt-shaped printing plate; and the continuous web form is zigzag-folded up to form a group of zigzag-folded unit forms constituting a text unit.

A notebook manufacturing apparatus 10 may be referred to as a rotary press printing machine whereby an elongated continuous web form (continuous paper, rolled paper) 12 supplied from a feed roll 11 is successively printed by elongated endless belt-shaped printing plates 13.

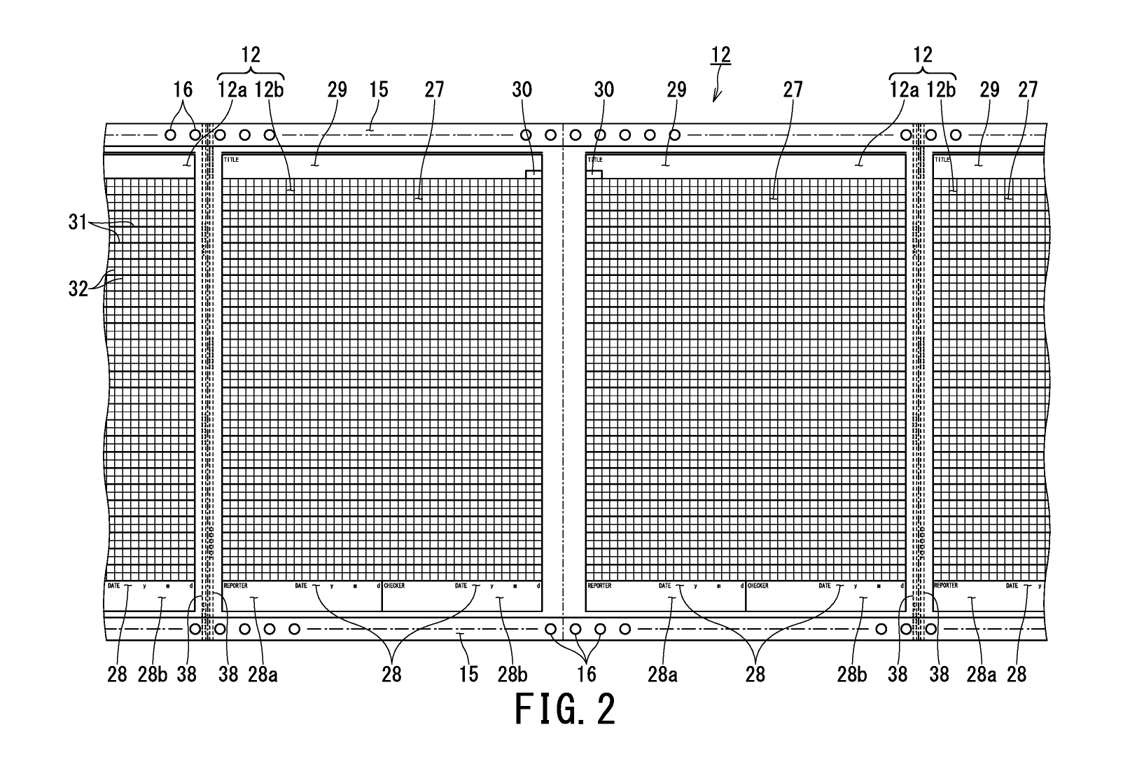

As shown in FIG. 2, the continuous web form 12 fed out of the feed roll 11 is provided with punched holes 16 at an equal pitch of e.g. ½ inch intervals along marginal zones 15 on both sides by a perforation apparatus (not shown). The punched holes 16 are formed as guide holes, whereby the continuous web form 12 is exactly guided and sent in the longitudinal direction thereof.

Thus, the continuous web form 12 sent out from the feed roll 11 is sent to a first printer 18 through a guide roller 17, and is suitably printed on its front surface or back surface, by the first printer 18. The continuous web form 12 is then sent to a second printer 19, whereby the continuous web form 12 is printed with watermarks, such as a school seal, a mark of cherry blossom, a company mark, etc. In case where such watermarks are not required, the second printer 19 may be slipped out or bypassed. The continuous web form 12 printed by the second printer 19 is sent to a form inverter device 20, whereby the front and back surfaces of the web form 12 are turned upside down. The reversed continuous web form 12 is then sent to a third printer 21 and a fourth printer 22 for printing on the other surface. The printers 18, 19, 21 and 22 each have an identical structure and identical function, and are used for respectively predetermined printings by using the respective endless belt-shaped printing plates 13 (13a, 13b, 13c, 13d).

The endless belt-shaped printing plates 13 of the printers 18, 19, 21 and 22 may be produced from a flexible elongated resinous relief printing plate disclosed in JP 5225237 B (Patent document 4) and JP 5389769 B (Patent document 3]). A plurality of the thus-produced resinous relief printing plates are connected one by one in a longitudinal direction, and then both longitudinal ends of the connected printing plates are connected to form an endless belt-shaped printing plate 13. The endless belt-shaped printing plates 13 are produced by connecting the resinous relief printing plates at an installation site of the respective printers 18, 19, 21 and 22, and are twisted around the respective printers 18, 19, 21 and 22.

The endless belt-shaped printing plates 13 are each formed of a flexible film-like resinous relief printing plate, and the respective endless belt-shaped printing plate 13 (13a, 13b, 13c, 13d) are each wound about a plate cylinder 23 and a guide cylinder (guide roller) 24 and are operated synchronously. More specifically, each endless belt-shaped printing plate 13 (13a, 13b, or 13c) may have a longitudinal and circumferential length appropriately selected from a range of several meters to several tens of meters, for example, 7m-50m. The endless belt-shaped printing plates 13a, 13b, 13c and 13d (13) have identical longitudinal lengths, and operated synchronously. However, endless belt-shaped printing plates 13a, 13b, 13c and 13d (13) may have different longitudinal lengths as far as they can perform a synchronous printing on a plurality of unit forms forming a unit form group.

The endless belt-shaped printing plate 13a wound about the plate cylinder 23 of the first printer 18 is equipped with, for example a pair of inking rollers 25a, to which a printing ink of predetermined color, such as black, blue or green, is supplied. The supplied printing ink is applied to the plate surface of the endless belt-shaped printing plate 13a. The printing ink applied to the plate side of the printing plate 13a is transferred for printing to the continuous web form 12 supplied from the feed roll 11. The continuous web form 12 is pressed by an impression cylinder 26, and the image on the endless belt-shaped printing plate 13a is printed to the continuous web form 12 by the pressure.

In the first printer 18, page faces (note faces) of unit forms 12a, 12b, . . . , as shown in FIG. 2, are formed by printing on the front surface or back surface of the continuous web form 12. Necessary information or a required data description column or space is formed on the page face of each unit form 12a, 12b.

A notebook produced by the notebook manufacturing apparatus 10 may suitably be used by a student, an engineer, or a researcher as a research, an experiment, or a document notebook. In case of using the notebook as a research-and-development note or a technical development note, each note face may be provided with a main data area 27 for indicating a progress of research or technical development, a study subject, contents of various actions, a memo, etc., and also a date space 28 for indicating year, month and day of record, an attestation (or acknowledgement) space 29 for superiors, a name space 30 for indicating the name of a person in charge and a participant, etc., and further a date space 28 for indication of year, month and day, a title space 29, a page number space 30. The date space 28 may further include a space 28a for indicating a name of reporter or entry person (person in charge) and an attestation space 29b for indicating a signature of a check person (a superior, a counselor, etc.).

The main data area 27 includes a note area in a form of, e.g., a grid or cells formed of horizontal ruled lines 31 and vertical ruled lines 32, wherein successive row numbers may be attached to rows between successive horizontal ruled lines 31, and successive page numbers are allotted to, e.g., an upper corner of, the respective note faces (page faces) of consecutive unit forms 12a, 12b of the continuous web form 12. Horizontal ruled lines 31 in the main data area 27 may be formed as solid lines or succession of relatively fine micro characters of 0.3P (point)-0.7P (point). In a specific embodiment, the horizontal ruled lines 31 are formed, e.g., as an alternation of a solid, dot or dashed line and a ruled line of a succession of micro characters.

The main data area 27 may include as an uppermost horizontal ruled line or thereabove a succession of characters having point sizes which sequentially increase or decrease in a range of from 0.3 point up to 2 to 4 point toward an end of the succession, or point sizes which become maximum or minimum at an intermediate point of the succession.

Herein, the term “micro characters” is used to mean characters, numerals or symbols which are at most 1 point (P=0.3515 mm) in size and cannot be recognized at least by observation with naked eyes to convey some meaningful data. Micro characters are collapsed when copied by using an ordinary copying machine, such as an electrophotography copying machine. A succession or row of micro characters is preferably incorporated as a horizontal ruled line for identification on a note face (form face).

The main data area 27 of each unit form 12a, 12b may include a horizontal ruled line 31 formed of printed micro characters having a point size of, e.g., 0.5 P (point) in a range of 0.3-0.5 P (point). Some example of the horizontal ruled line 31 is described later.

After the page faces (form faces) of the unit forms 12a, 12b, are consecutively printed on one surface (form surface) of the continuous web form 12, the continuous web form 12 is guided to a second printer 19, where watermarks 33 of the shape of, e.g., a cherry petal, are printed on the respective note faces (page faces, form faces) of the unit forms 12a, 12b of the continuous web form 12 by inking rollers 25b and an endless belt-shaped printing plate 13b of the second printer 19. Such watermarks may be attached in order to express a looking of high-class printing and may also be given as other shapes than petals, or a mark or name of a company, etc.

After the page faces (note faces) of the unit forms 12a, 12b, are printed by the first printer 18 and the watermarks are printed on the note faces by the second printer 19, or after the second printer 19 is slipped out in case where the watermarks are not required, the continuous web form 12 is sent to the form inverter (or turnover) device 20 where the back and front surfaces of the continuous web form 12 are reversed.

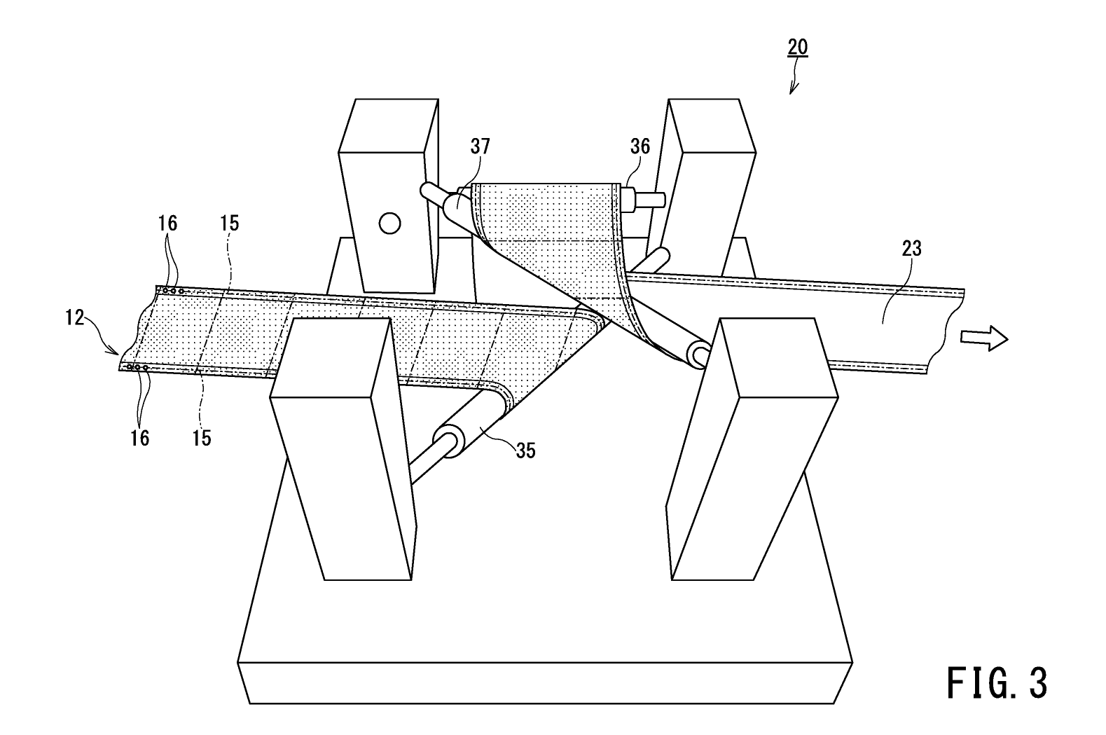

The form inverter 20 may be composed as shown in FIG. 3, and the continuous web form 12 conveyed thereto is guided to a lower guide bar 35 inclined 45 degrees to the run direction so that the non-printed (e.g., front) surface of the web form 12 contacts the bar 35, further guided toward a lateral side and then inverted upside down by a rotatably disposed guide bar 36. At the guide bar 36, the web form 12 is guided upwards and then turned over. The reversed continuous web form 12 is led to an upper guide bar 37, where its run direction is changed so as to intersect perpendicularly with the previous one. The upper guide bar 37 crosses so as to intersect perpendicularly or in a character “X” to the downward guide bar 35 as viewed in plane, and the continuous web form 12 is further turned upside down to be guided to a third printer 21.

In the third printer 21, printing is continuously performed onto the front (or back) surface of the continuous web form 12 similarly as in the first and the second printers 18 and 19 using an endless belt-shaped printing plate 13c and the inking rollers 25c. In a specific example, by the third printer 21, the same printing as the first printer 18 is performed to the front (or back) surface of the continuous web form 12. Thus, a series of printings can be continuously performed to the front and back surfaces of the continuous web form 12 by the first printer 18 and the third printer 21.

After a series of printings are effected on the front and back surfaces by passing a third printer 21, the continuous web form 12 is sent to the fourth printer 22. In the fourth printer 22, a liquid-form release agent 38 (liquefied wax or nonflammable oil for peeling) is applied in stripes on the back or front face of the continuous web form 12b in proximity to both sides of a rouletted fold line which partitions neighboring page forms (form faces) 12a and 12b as described below. More specifically, the liquid-form release agent 38 is applied on a back or front surface of the continuous web form in proximity to both sides of a rouletted fold line partitioning the respective unit forms 12a and 12b in stripes with a spacing therebetween which is, e.g., several to ten times the paper thickness of the unit forms 12a, 12b, e.g., a minor spacing of about 0.6 mm-2 mm. The liquid-form release agent 38 (see FIG. 2) is applied so that, when a text unit 50 is formed by folding zigzag a preset number of successive unit forms as will be described later, a portion of the release agent is exposed onto one folded side of the text unit 50 (i.e., a back or an outer ridge side of the unit from group 46).

After the printing on both surfaces is performed, the continuous web form 12 is led to the inspection device 40, where the continuous web form 12 is inspected with respect to a positional deviation, printing unevenness, etc., as desired. The inspected continuous web form 12 is then guided to and cut in a form width direction for every preset number of unit forms by a cutting machine 41, and then guided to a zigzag folding machine 44. Alternatively, it is also possible to place the cutting machine 41 after the zigzag folding machine 44 and for cutting the continuous web form 12 processed by the zigzag folding device 44 in the form width direction for every unit form group comprising a preset number of unit forms to form a text unit comprising the unit form group.

As the zigzag folding apparatus 44, a zigzag folding apparatus equipped with a fold line generator as disclosed in JP5324950B (Patent document 2) may be used for example. According to such a zigzag folding apparatus, the continuous web form 12 is alternately provided with a ridge-like projection line or a valley-like depression line (each functioning as a fold line) in transverse directions for every unit form 12a, 12b, . . . . The zigzag folding apparatus 44 is equipped with such a fold line generator and a press for fixing the resultant fold lines, whereby the continuous web form 12 is provided with a zigzag-folded state having a projecting ridge and a valley alternately for every unit form 12a, 12b.

More specifically, the zigzag folding apparatus 44 may have a streak-folding press including a male edge attached to a ridge-like projection, and a female edge forming a valley-like depression and engaging with the male edge, thereby forming a rouletted fold line in a form width direction for every unit form. The rouletted fold line is formed as a row of multiplicity of minute perforations formed in a form width direction of the continuous web form 12. The minute perforations are formed, e.g., at a 2 mm pitch, for every unit form.

The continuous web form 12 is folded zigzag with the zigzag folding apparatus 44 along the rouletted fold line of micro perforations for every unit form. The continuous web form 12 folded up zigzag is sent out on a stacker 45, and is piled up gradually. The continuous web form 12 deposited on the stacker 45 is cut crosswise in the width direction thereof by a cutting machine 41 for every preset number of unit forms to provide a text unit 50 of a unit form group 46 including a preset number, e.g., 40 or 60 sheets, of unit forms. The text unit 50 is deposited one by one in a necessary number.

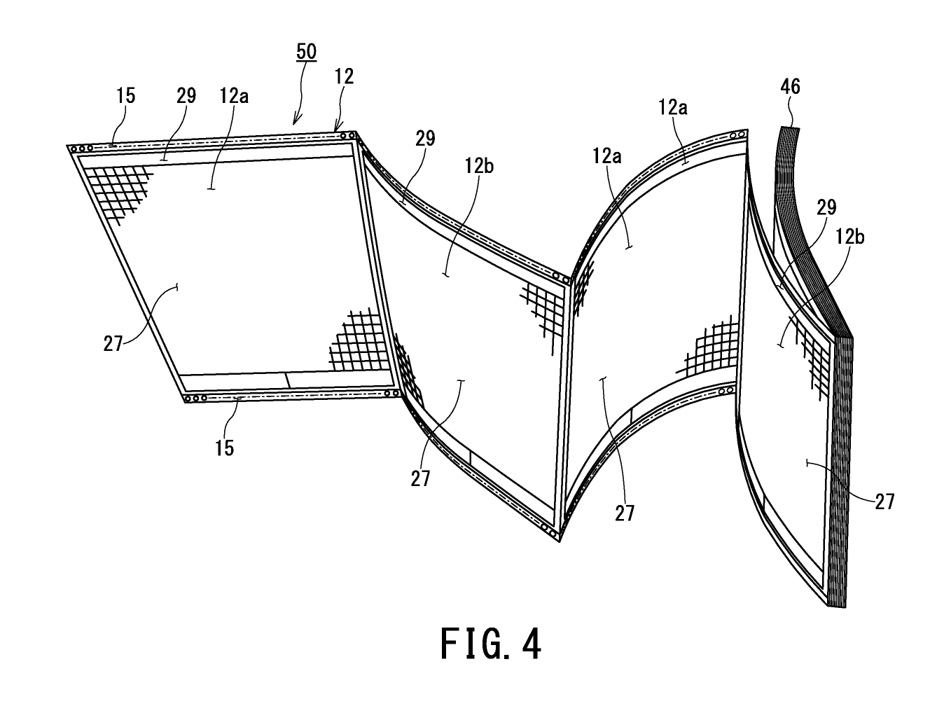

The text unit 50 consisting of the group 46 including the preset number of unit forms is formed as follows, e.g. as shown in FIG. 4. The text unit 50 is formed of a preset number of unit forms so that successive unit forms 12a, 12b constituting the continuous web form 12 are folded alternately with an inward (valley-like) fold and an outward (ridge-like) fold. An adjacent pair of a unit form 12a and a unit form 12b are folded inwardly, and a succeeding pair of the unit form 12b and a unit form 12a are folded outwardly, so that the unit form group is folded up zigzag. Main data areas 27, 27 of the inwardly folded pair of the unit forms 12a, 12b are separated with a spacing therebetween which is smaller than a spacing between unit forms 27, 27 of the succeeding outwardly folded pair of 12b, 12a (See FIG. 2). A larger spacing between the outwardly folded adjacent pair of main data areas 27, 27 is provided because a portion including the outward (ridge-like) fold line is thereafter cut off during a process of making the notebook 50 as will be described later.

Thus, the text units 50 each comprising a unit form group 46 including the preset number of unit forms 12a and 12b are formed with the zigzag-folded continuous web form 12 stacked on the stacker 45. The text units 50 are cut out and separated from each other for every unit form group and are processed by a bookbinding press device (not shown) as will be described later to provide a notebook 55 including the text unit.

[Notebook]

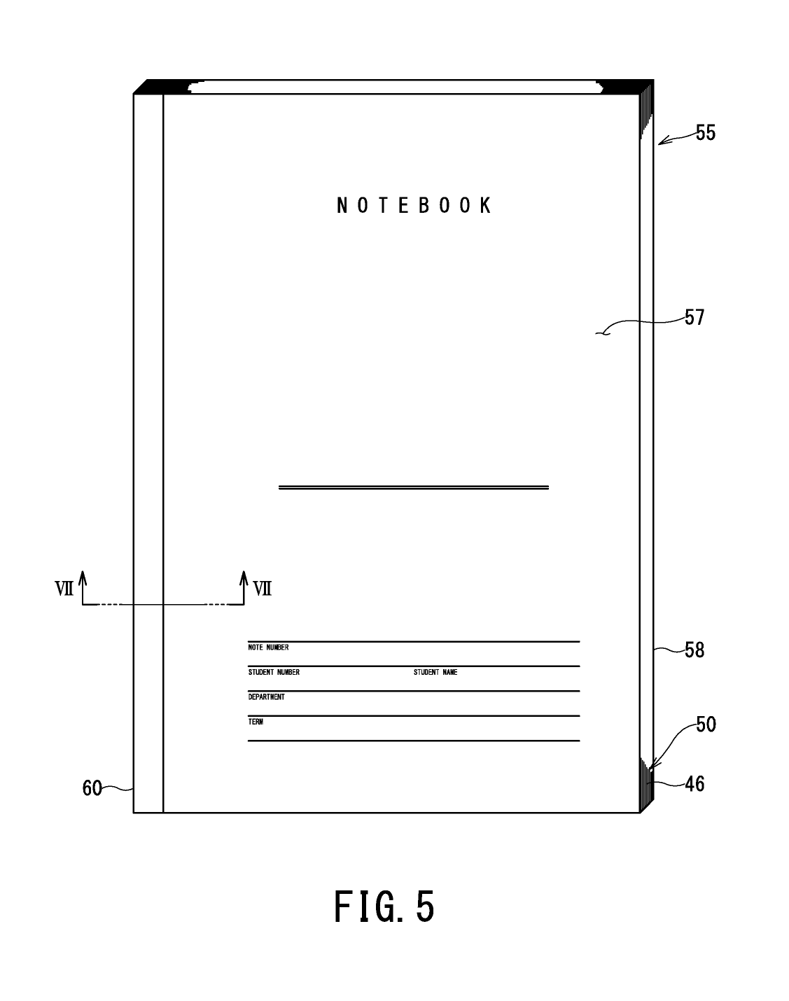

A notebook 55 is produced from such a text unit 50 of unit form group 46, e.g., as shown in FIG. 5, for example. The notebook 55 includes a text unit 50 comprising a preset number of paper sheets each having a unit form printed on both surfaces thereof as contents.

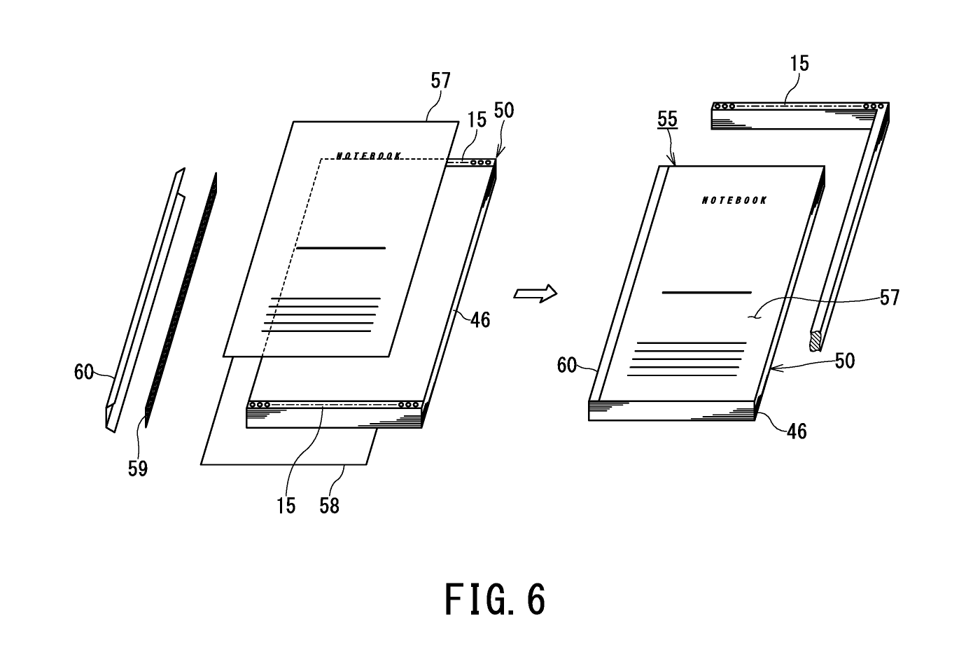

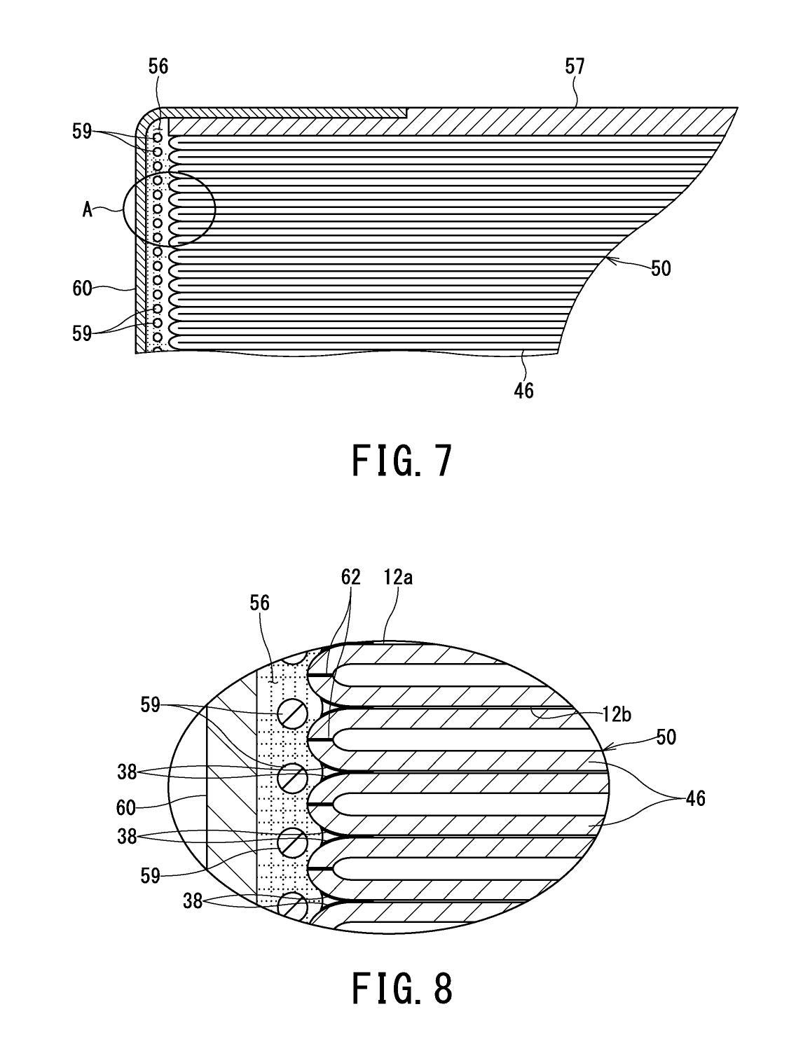

More specifically, a notebook 55 may be produced (manufactured) from a text unit 50 as shown in FIGS. 6 and 7, by superposing on both sides of the text unit 50 a front cover 57 and a back cover 58, applying an adhesive 56 and a mesh cloth 59 to be impregnated with the adhesive and pressed onto a whole back side (or edges) of the superposed front cover 57, text unit 50 and back cover 58, and disposing thereon a spine 60 so as to cover and wrap the back of the superposition for integration of the members. Actually, the production of such a notebook 55 is performed by means of a well-known bookbinding press device.

The spine 60 is pressed and bonded onto the whole backside of the superposed front cover 57, text unit 50 and back cover 58 via the mesh cloth 59. The spine 60 wraps the backside of the front cover 57, text unit 50 and back cover 58 from the outside by the medium of the mesh cloth 59 for bonding and integration.

After the integration by wrapping from the outside of the superposed front cover 57, text unit 50 and back cover 58 with the mesh cloth 59 as shown in FIG. 6 and FIG. 7, three sides (a marginal zones 15 and one side) except for one back side of the text unit is cut off by a cutting device (not shown) to produce a notebook 55. By the cutting-off of the three sides, the text unit is converted into a laminate of a multiplicity of superposed unit form pairs each comprising a twofold folio of unit forms 12a and 12b which are connected with each other via a rouletted fold line.

In the above process, the adhesive 56 applied to the backside (one side edge) of each unit form group 46 constituting the text unit 50 is repelled by a release agent 38 applied in stripes near both sides of the fold line between the unit forms 12a and 12b, as shown in FIG. 8. The adhesive is repelled by the release agent 38 applied onto outer (ridge) sides of the unit forms 12a and 12b formed by double folding so that adhesion by the adhesive 56 is not caused at portions where the release agent 38 is applied.

A spine 60 is disposed to wrap and cover the whole back edge of the superposed front cover 57, text unit 50 and back cover 58 to form a notebook 55. The spine 60 may be disposed to cover from the back edge side of the front cover 57 via the text unit 50 up to the back edge side of the cover 58 so as not to form a stepwise difference at a joint of the spine 60 with the front cover 57 or the back cover 58 due to the thickness of the spine 60. For this purpose, back edge side portions of the front cover 57 and the back cover 58 are recessed in stripes by a press, etc. This is effective for preventing an inclination of notebooks 55 when they are stacked. The notebook 55 may be equipped with one or plurality of bookmark string or strip (not shown) bonded to the mesh cloth 59 with the adhesive 56 for separation between pages of the notebook 55.

It is also possible that the spine 60 is bonded so as to to wrap and cover the back side edges of the front cover 57, text unit 50 and back cover 58 while leaving a step-wise difference due to the spine 60 on the back side of the notebook 55.

In the above-described embodiment, the notebook 55 is formed with three members of the front cover 57, the back cover 58 and the spine 60, it is also possible that the front cover, the spine and the back cover are integrally formed with a single leaf of paper. It is also possible that the front cover 57, the spine 60 and the back cover 58 are made of leather or a resin material. In that case, in order to make easy the spreading of the notebook 55, fold lines for facilitating bending may be provided between the front cover part and the spine part and the spine part and the back cover part so as to make easy the transition between the spread state and the closed state. Further, for the purpose of reinforcement, a spine 60 of a book binding cloth paper or fabric can be additionally applied on the spine part from the outward.

By the way, the cutting of 3 sides (side portions) of the text unit 50 by a cutting device may be performed beforehand when the text unit 50 is formed from a group 46 of a preset number of unit forms. In this case, a text unit having removed three side portions is sandwiched between a front cover and a back cover after a positional alignment. Onto the thus-aligned and superposed front cover 57, text unit 50 and back cover 58, a mesh cloth 59 impregnated with the adhesive 56 may be applied and pressed for bonding, followed by wrapping with a spine from outwards to provide a notebook 55.

The mesh cloth 59 may comprise superfine fabric, crash or gauze cloth woven in an interlaced state capable of smooth impregnation with a liquid state adhesive (e.g. of a single liquid type). The spine 60 may comprise, e.g., a cloth paper for bookbinding or a cloth fabric.

When a mesh cloth 59 impregnated or applied with an adhesive 56 is pushed against the whole back side of the superposed front cover 57, text unit 50 and back cover 58, the liquid adhesive 56 is pushed out against the backside of the front cover 57, text unit 50 and back cover 58 to promote an adhesion function. The liquid adhesive 56 pushed against one back side of the text unit 50 intimately contacts folded lines (with micro perforations 62 of respective rouletted fold lines) between respective pairs of unit forms 12a, 12b as shown in FIGS. 7 and 8 but is repelled by the release agent 38 applied near the folded lines, so that the ridge-sides of the unit forms 12a and 12b at parts applied with the release agent are not bonded with each other. Further, a portion of the adhesive 56 penetrates through the micro perforations 62 into the group of unit forms to enhance the adhesion between the unit forms 12a, 12b. The adhesive 56 is then solidified in a preset time to provide an integrated notebook 55. The front cover 57 and the back cover 58 may have a thickness which is several times, e.g., from 2 to 5 times that of each unit form 12a, 12b constituting the unit form group 46 of the text unit 50.

The notebook 55 shown in FIG. 5 has a front cover 57 including a title (theme) and blank spaces for miscellaneous matters, such as a note number, a student number, a name, an affiliation faculty name, a period of use, e.g., when the notebook 55 is used as a research and development/experiment note for students.

Further, the reverse face of the front cover 57 may indicate items (1), (2) and (3) shown below, as Notice information.

(1) Recommendation on Use of or Writing in the Product.

For example, an explanatory remark that a user, such as a researcher, an educator, an engineer or a student, should arrange and record the contents, idea, etc. of research and development and experiment activities, in a chronological order, and an explanation of matters appropriate for writing in a notebook or studying a management method to a researcher, a student or an engineer.

(2) Characteristics of the Product

The research notebook has been printed with micro characters and realizes an enhanced security effect. The main data area of the notebook is formed with horizontal ruled lines, solid lines (dotted lines) and micro characters constituting a grid as a whole, so that it is convenient for writing a mathematical formula, a graph, a plan, etc.

The notebook is equipped with integral appendixes including a periodic table of elements, fundamental physical constants, an international unit (SI unit) system, a table for conversion of physical constants, graphic symbol for electrical items, Greek characters and phonetic indications thereof, etc., and also remarks for promoting practical use in describing details of research.

(3) Recommendations for Description

1. A ball-point pen or a pen with a lightfast and waterproof blue or black ink should be used for writing.

2. Recording in the notebook should be done on the day of work, such as research, experiment, etc.

3. Correction of an error should be done not with a correction fluid but with a double line and a correct description together with a date of the correction and a signature of the person in charge.

:

n. Fill in a date and get a check person's signature at the end of a description.

A sample of the desirable example of entry (statement) may be printed on the first unit form of the text unit 50 constituting the notebook 55 as needed. Alternatively, such an example description may be inserted as a separate sheet of paper following the front cover of the notebook 55.

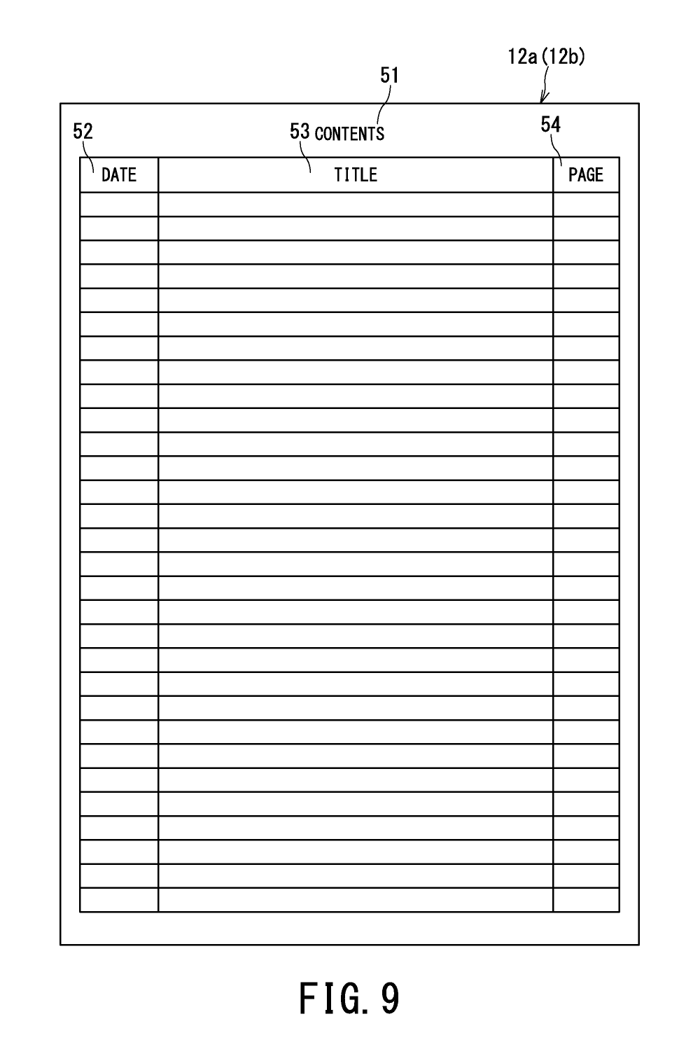

In addition, the text unit 50 constituting the notebook 55 may include a printed table-of-contents (CONTENTS) page 51 as shown in FIG. 9 as a first unit form or on the back side of the first unit form indicating the example description.

The table-of-contents (CONTENTS) page 51 of the notebook 55 may include a date column 52, a title column 53 and a page column 54, so that the user of notebook 55 may fill in a title for every work of research, experiment, etc., or for every project. The table-of-contents page 51 may be formed on plural, e.g. 2 or 3, pages of unit forms 12a (12b), in case of many titles of research, experiment, etc.

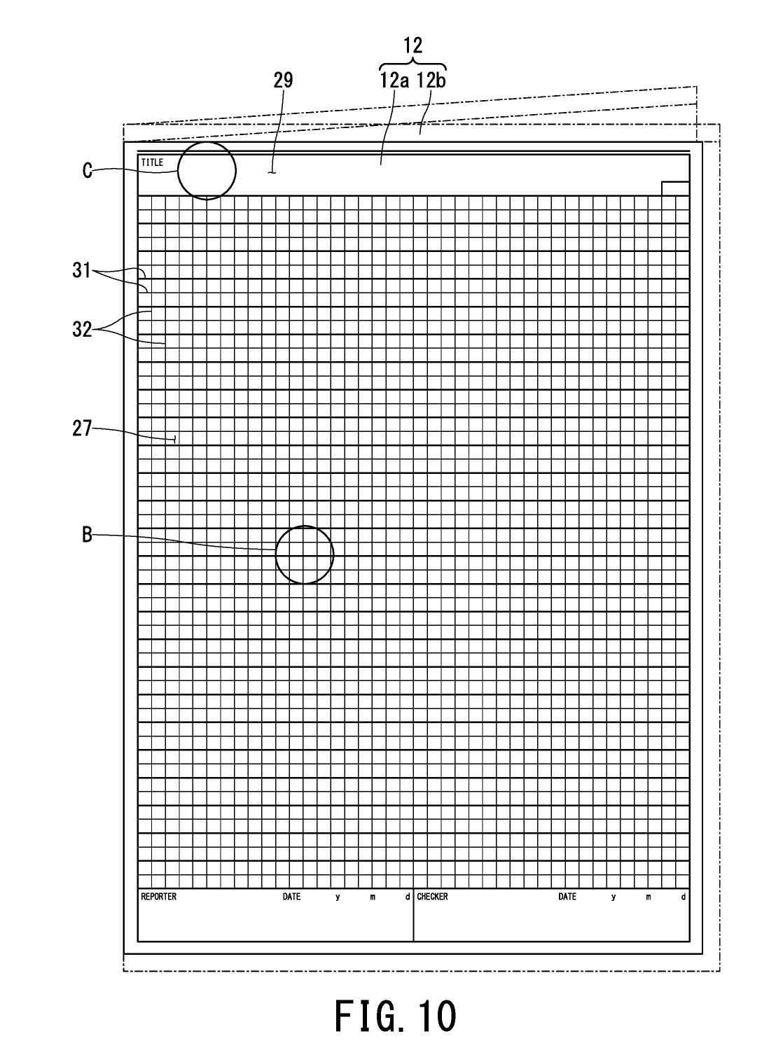

Each unit form group (text unit 50) constituting the notebook 55 includes one or plural sheets of unit forms of printed table-of-contents page 51, followed by unit forms 12a (12b) of printed main description pages 27, as shown in FIG. 10.

A preset number of unit forms forming a group 46 are folded zigzag and stacked to form a text unit 50. In a notebook 55 produced from the text unit 50, a pair of unit forms 12a and 12b are folded inside to form a valley, and a multiplicity of such folded pairs are stacked to form a unit form group 46 as shown in FIGS. 7 and 8. Therefore, in the unit form group 46, the unit forms 12a, 12b are not independent from each other, and neighboring unit forms 12b and 12a are connected via a fold line of micro perforations 62. Then, the unit form group 46 (including a preset number of unit forms) is sandwiched between a front cover 57 and a back cover, and a liquid adhesive 60 and a mesh cloth 59 are applied and pushed against the whole back side of the superposed front cover 57, unit form group 46 and back cover 58 to be integral with each other, and then a spine 60 is applied from outside the mesh cloth 59 so as to wrap the back or ridge of the front cover 57, unit form group 46 and back cover 58, thereby forming a notebook 55.

In the production of the notebook 55, a mesh cloth 59 impregnated with an adhesive 60 by application of the latter may be applied onto the whole backside of the stacked front cover 57, text unit 50 and back cover 58 for integration. In case where the adhesive 60 is insufficient by simple application of a mesh cloth impregnated with an adhesive 60, an additional amount of adhesive 60 may be applied against the back of the mesh cloth 59 to enhance the bonding of the mesh cloth 59 with the front cover 57, text unit 50 and back cover 58 and also with the spine 60.

The notebook 55 thus produced includes a text unit 50 formed of a group 46 of a preset number of unit forms, in which a multiplicity of neighboring pairs of unit forms 12a and 12b each folded in a pair are stacked. Against the ridges of the folded pairs, a cloth mesh 59 impregnated with an adhesive 60 is pressed, whereby the ridge of the stacked unit form group 46 is in surface contact with the mesh cloth 59 via the adhesive 56 except for parts applied with a release agent 38. Each folded pair of neighboring unit forms 12a and 12b in the stacked unit form group 46 are connected with each other via a fold line of micro perforations 62 and are not independent from each other. The adhesive 60 applied over the ridge of the neighboring pair of unit forms 12a and 12b penetrates through the micro perforations 62 is further effective for enhancing the bonding (adhesion) strength between the unit forms 12a and 12b.

Moreover, even in the spread state of the notebook, the ridges except for the stripe portions applied with the release agent 38 of all the folded pairs of unit forms 12a and 12b are bonded in plane with the mesh cloth 59, and each neighboring pair of unit forms 12a and 12b are connected with each other via a fold line of micro perforations 62 into which the adhesive penetrates. Each pair of unit forms 12a and 12b of the unit form group 46 constituting the text unit 50 keep an integral connection on their ridge side with the fold line of micro perforations 62, so that the respective unit forms can realize a desirable spread state. Therefore, it is easy to write characters, graphic charts, graphs, etc. onto each unit form 12a, 12b of the notebook 55, thus providing an improved user-friendliness.

The notebook 55 allows the opening to a perfect spread state (180-degree horizontal state) of any arbitrary page. Thus, it becomes possible to register, indicate or record on respective spread pages in a deformation trace-free perfect spread state (180-degree horizontal state). Therefore, copying on a spreading table of a copying machine also becomes easy.

The text unit 50 constituting the notebook 55 is formed of a unit form group 46 including a stack of unit form pairs 12a and 12b each formed by folding a paper sheet in half. Each unit form 12a (12b) has a main data area 27 provided with an arrangement of cells or grid formed by intersection of horizontal ruled lines 31 and vertical ruled lines 32. The horizontal ruled line 31 and vertical ruled lines 32 are printed, e.g., 5-mm intervals, using blue ink or green ink. Every other horizontal ruled line 31 may formed as a succession of micro characters. Micro characters may be printed as characters, symbols or numerals in an arbitrary size of, e.g. 0.5 P (point), selected from a range of 0.3 P to 0.7 P. The micro characters are hardly recognizable as data which have meanings at least with naked eyes and are collapsed when reproduced by copying machines, so that the notebook 55 may be provided with high security and functionality.

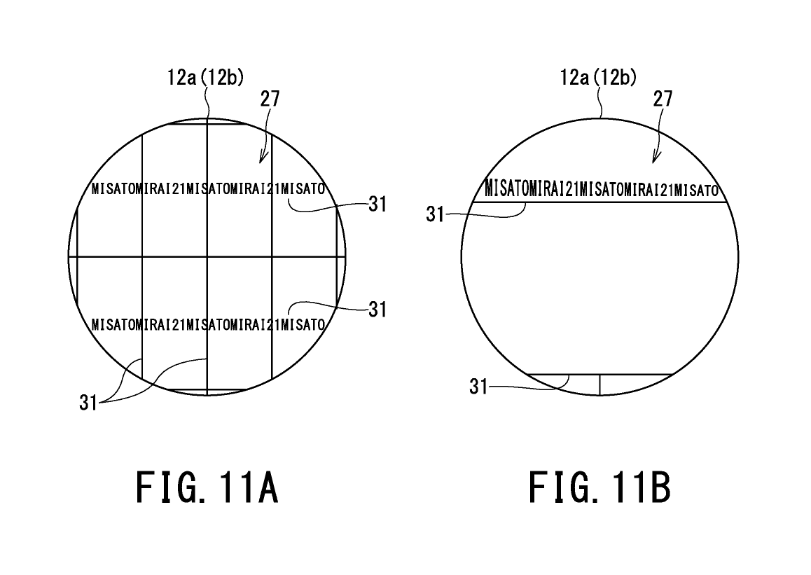

The notebook 55 may include a unit form having a print pattern including an uppermost or lowermost ruled line or a line above the horizontal ruled line formed of characters having point sizes which sequentially change in a range of from 0.3 point up to 2 to 4 point, e.g., so as to increase from the beginning toward a middle point of the line to assume a maximum and then gradually decrease toward the end of the line, as shown in FIG. 11B. A lot of variations may be adopted to provide a further improved security.

The text unit 50 of the notebook 55 may further include a periodic table of elements, a list of major physical constants and units (fundamental physical constant table), graphic symbols for electrical illustrations, Greek characters phonetical readings thereof, as an appendix at the end. It is possible to further include a table for conversion of units (of length, areal size, volume, mass, weight, strength, energy, conversion power, pressure, etc.), a list of fundamental mathematic formulas (algebra, trigonometric functions, hyperbolic functions, opposite functions, differentiation and integration, geometric formulae), as desired.

The major physical constants and units may include the International System of Units (SI) including SI basic units, SI derived units, SI fractional units, SI prefixes, and units that are combined with SI units.

Such appendix materials may be attached to the end of a note book or as a separate volume. It is also possible to print such appendix materials by the printers 18 and 21 and include them as a portion of the unit form group 46 and include them integrally in the text unit 50.

### Second Embodiment

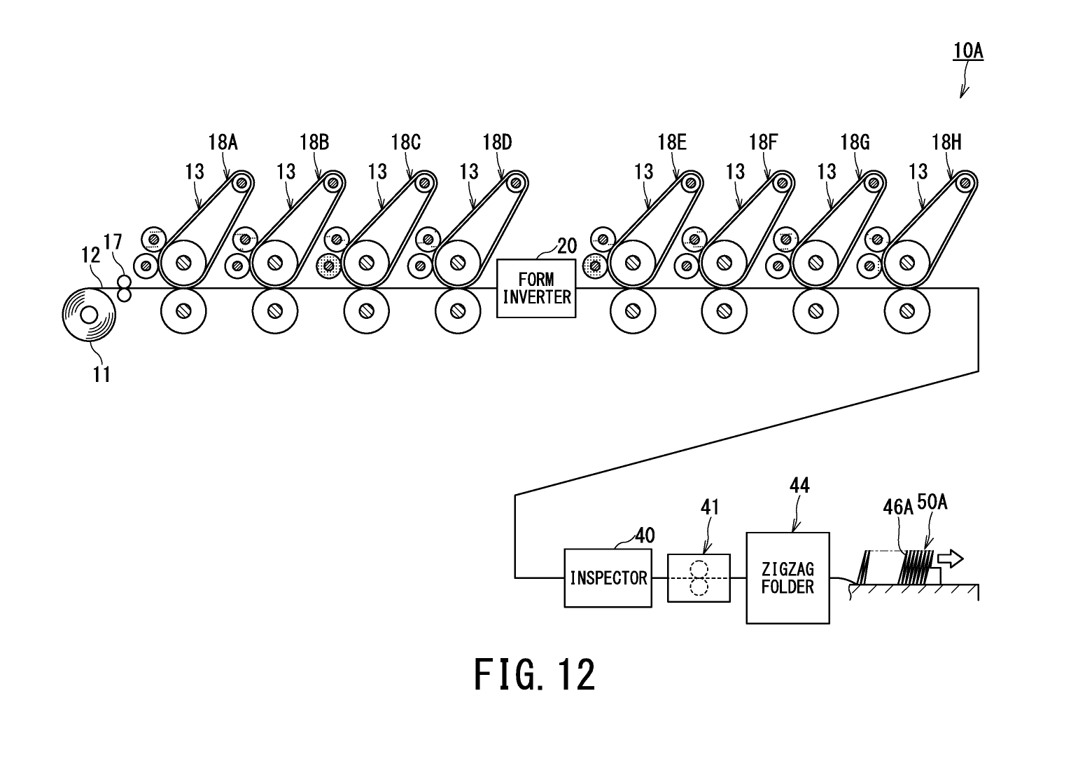

There has been described a first embodiment of notebook 55, wherein a necessary number of unit forms in the unit form group 46 constituting the text unit 50 are printed by using green ink or blue ink, whereas the unit forms can also be provided by full-color printing. Such full-color printing may be performed, e.g., by a notebook manufacturing apparatus, as shown in FIG. 12, whereby one side of continuous web form 12 is printed by using at least four printers 18A, 18B, 18C and 18D using red, blue, green and black inks, respectively. Then, the continuous web form 12 is reversed by a form inverter 20, and the remaining other side thereof is printed, e.g. by four printers 18E, 18F, 18G and 18H. Then, the continuous web form 12 printed on both sides thereof is folded zigzag for every unit form and stacked to provide a text unit 50 comprising a group 46 including a preset number of unit forms. Thereafter, a full-color-printed notebook or booklet is prepared from the text unit 50 similarly as in First embodiment described above. Accordingly, the production of a full-color-printed notebook or booklet may require a plurality, e.g. 4, of printers on each side and totally 8 (or 9) printers.

Further to add, the production of a two-color-printed notebook may require at least 2 printers on each side and totally 4 printers, and the production of a three-color-printed notebook may require at least 3 printers on each side and totally 6 printers.

### OTHER EMBODIMENTS

In the above, an embodiment of the present invention has been described, wherein a notebook 55 suitable for research, experiment, or as a document note, is produced, whereas the notebook is not limited to those suitable for such use.

The notebook of the present is also applicable to a conferenced or meeting note, or an idea note. The conference note may be produced similarly as the notebook 55 shown in the first embodiment. Such a conference note may require a main data area 27A, which however need not require an arrangement of cells or grid formed by intersection of horizontal ruled lines 31 and vertical ruled lines 32 as in the first embodiment.

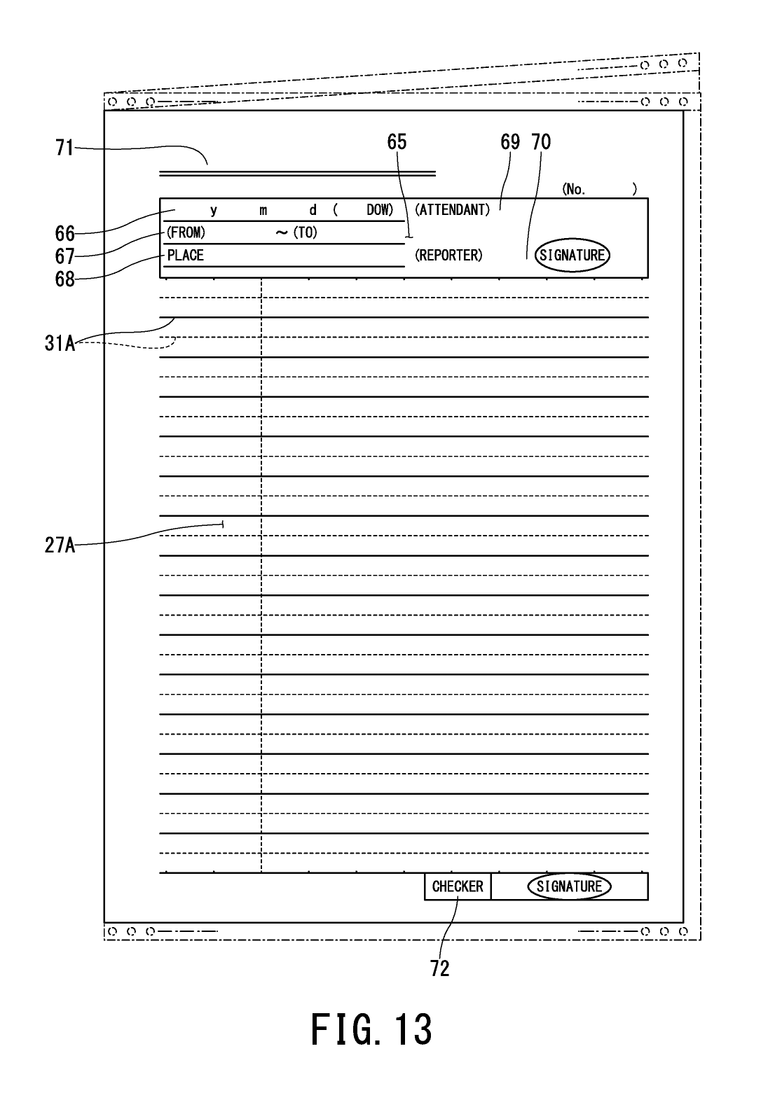

It is sufficient for such a conference note, e.g., as shown in FIG. 13, that the main data area 27A is formed only by horizontal ruled lines 31A of a solid line or a dotted line. The horizontal ruled lines may include a solid line or a dotted line formed of a succession of micro characters of 0.3 P-0.7 P, at a desired part.

A remaining space 65 in the main data area 27A may be provided as a space required for indicating miscellaneous matters relating to the conference, such as preparation of minutes, including spaces for recording date (year, month, day (of week)) 66 of a conference, time 67, a place 68, conference attendants 69, reporter's name 70.

The conference note may be provided with a title space 71, as desired, for indicating a subject for discussion, and matters for consideration of the conference, and further a minutes validation space 72 for recording a name and a signature of a manager or a like person.

Similarly as the notebook 55 of the first embodiment, the conference note is produced by providing a stack of a front cover, a text unit (comprising a preset number of unit forms) and a back cover, pressing a mesh cloth impregnated with adhesive 56 onto the back side of the stack, and disposing a spine over the back side via the mesh cloth so as to wrap the stack. On the front cover of the conference note, necessary information relating to the relevant organization or agency, may be printed.

In the above, some embodiments of the notebook of the present invention, usable as a research and experiment/document note, a conference note or an idea note, whereas the notebook can also be used as a risk management note, an SOS note, an information management note, or a diary, and also as a coloring note for a kindergartner or a child. In the case of a coloring note, the text unit may include unit forms with a main data area having printed dotted lines as a draft or blank spaces.

An example of the above-mentioned risk management note has been proposed to have a note face of each unit form including columns or space for fill in necessary data for personal arrangement or self-control, such as various assets, liabilities, illness, and care, information for the life of every day, etc. Details of contents therein may be available in, e.g., “moshimo note” (roughly meaning a provident note)”, written by Michiko Susai, published from Life and Ending Center (a non-profit organization) (2004).

Moreover, as an example the an information control note, it may be possible to refer to “EVER NOTE”, written by Shinya Kita, published from K.K. Gijutsu Hyouron-sha (2011), which has proposed a note face of” each unit form including an information arrangement column (or space) for collecting information of concern, an information processing space, an information check space, an information application space, etc.

Furthermore, while there has been described an embodiment wherein a notebook manufacturing apparatus is used to successively produce one or plural group(s) of unit forms successively from a continuous web form, it is also possible to use a type of notebook manufacturing apparatus using a wide endless belt-shaped printing plate for printing on a continuous web form having a large width to produce plural (e.g. two) groups of unit forms in parallel.

The first embodiment of the present invention refers to an example wherein a watermark is printed by a second printer 19, and a release agent is printed in stripes by a 4th printer 22, whereas the second printer 19 and the fourth printer 22 may be disposed conversely. In this case, a release agent is printed in stripes by the second printer 19. In the case of printing a release agent in stripes on unit forms, neighboring unit forms 12a and 12b are folded so as to form a ridge (or a valley), and neighboring unit forms 12b and 12a are folded so as to form a valley (or a ridge).

In the above, some embodiments of the present invention have been described, these embodiments are shown as examples, and it is not intended that the scope of the invention is limited thereby. These novel embodiments can be exploited in various modified forms, and within an extent not deviating from the gist of the invention, various omissions, replacement and modifications are possible within the scope of the present invention. Such embodiments and modifications thereof are included in the scope and the gist of the invention and also included in the invention recited in the claims, and equivalents thereof.

### NUMERALS IN THE DRAWINGS

10: notebook manufacturing apparatus, 11: feed roll; 12: continuous web form, 12a, 12b: unit forms, 13: endless belt-shaped printing plate, 15: marginal zone, 16: punched hole, 18: first printer, 18A-18N: printers, 19: second printer, 20: form inverter, 21: third printer, 22: fourth printer, 23: plate cylinder, 24: guide cylinder (guide roller), 25: inking roller, 26: impression cylinder, 27, 27A: main description area, 28: date space, 28a, 28b: space for names (space for signature), 29: title space, 30: page number space, 31, 31A: horizontal ruled line, 32: vertical ruled line, 35: lower guide bar, 36: guide roller, 37: upper guide bar, 38: liquid release agent, 40: inspection device, 41: cutter, 44: zigzag folding device, 45: stacker, 46: unit form group, 50, 50A: text unit, 51: table-of-contents page 52: date column, 53: title column, 54: page column, 55: notebook, 56: adhesive, 57: front cover, 58: back cover, 59: mesh cloth, 60, 60A: spine, 62: rouletted line (micro perforations), 65: space, 66: date of conference, 67: time of conference, 68: place of conference, 69: attendants, 70: reporter, 71: title (theme) space, 72: attestation space.

1. (canceled)

2. The notebook according to claim 10, wherein a release agent is applied in stripes on both sides of each ridge formed on one folded side of the multiplicity of stacked folded sheet pairs forming the text unit.

3. The notebook according to claim 10, wherein each unit form has a form face, and the form face includes a main data region equipped with a plurality of horizontal ruled lines, and the horizontal ruled lines include a ruled line formed of micro characters.

4. The notebook according to claim 3, wherein the horizontal ruled lines in the main data region comprise ruled lines formed of micro characters of from 0.3 point to 0.7 point and ruled lines formed of solid or dotted lines.

5. The notebook according to claim 3, where in the main data region is entirely formed of a mesh of horizontal ruled lines and vertical ruled lines as a whole.

6. The notebook according to claim 10, having a print pattern characterized by an uppermost or lowermost ruled line or a line above the horizontal ruled line that is formed of characters having point sizes which sequentially increase or decrease in a range of from 0.3 point up to 2 to 4 point toward an end of the line, and the point sizes become maximum or minimum at an intermediate point of the line.

7. The notebook according to claim 10, wherein said spine comprises a binding cloth paper or fabric, and said mesh cloth comprises a meshed cheesecloth or gauze cloth.

8. The notebook according to claim 10, wherein outer surfaces of said front and back covers are each recessed in a stripe form along the one folded side of the stacked unit form group,
said spine is formed of a binding cloth paper and disposed to straddle over the recessed part of the front cover and the recessed part of the back cover so as to be flush with the front cover and the back cover.

9. (canceled)

10. A notebook, comprising:
a stack of folded unit form group (text unit) formed by stacking a multiplicity of sheet pairs each comprising a pair of neighboring unit forms connected and folded with each other via a rouletted fold line,
a mesh cloth impregnated with a liquid adhesive and directly applied against a back folded side of the unit form group for adhesion, and
a front cover, a spine and a back cover disposed so as to wrap the unit form group, thereby providing an integrated notebook structure.

11. The process for producing a notebook according to claim 17, wherein:
said one folded side is cut off while leaving the other folded side of the text unit before or after the disposition of the spine onto the stack of the front cover, the text unit and the back cover.

12. The process for producing a notebook according to claim 17, wherein said continuous web form is provided through steps of:
successively printing a multiplicity of unit forms including horizontal ruled lines formed of a succession of micro characters by a printer equipped with an endless belt-shaped printing plate on one surface of a continuous web form,
inverting the front and back surfaces of the continuous web form with a form inverter,
printing on the other surface of the continuous web form a multiplicity of unit forms including a horizontal ruled line formed of a succession of micro characters by another printer equipped with an endless belt-shaped printing plate to provide the continuous web form with prints on both surfaces.

13. A process for producing a notebook according to claim 17, wherein said rouletted hold line is provided between each neighboring pair of unit forms by micro rouletting in a width direction of the continuous web form.

14. The process for producing a notebook according to claim 17, wherein the disposition of the mesh cloth impregnated with an adhesive between the back of the stack of the front cover, text unit and back cover and the spine, is performed by pressing of the spine onto the back of the stack so as to wrap the latter, after successive application of the adhesive and the mesh cloth or application of the mesh cloth preliminarily impregnated with the liquid adhesive onto the back of the stack.

15. (canceled)

16. The notebook according to claim 10, wherein said front cover, spine and back cover are formed of a single sheet of paper.

17. A process for producing a notebook according to claim 10, comprising:
providing an elongated continuous web form having a multiplicity of unit forms successively printed with spacing therebetween along a length on both surfaces thereof together with a rouletted fold line formed in each spacing between the successive unit forms,
folding up zigzag the continuous web form for every unit form with the rouletted fold lines,
cutting and separating the continuous web form for every preset number of successive unit forms in a form width direction to form a zigzag-folded text unit,
cutting off at least one side including one folded side while leaving the other folded side of the text unit, thereby forming a text unit comprising a stack of multiplicity of folded sheet pairs each of which is connected via the rouletted fold line,
sandwiching the text unit with a front cover and a back cover, and
covering and wrapping a side including said remaining the other folded side of the text book of the resultant stack of the front cover, the text unit and the back cover directly with a mesh cloth impregnated with a liquid adhesive, and further with a spine, to form an integrated notebook.

18. The process for producing a notebook according to claim 17, further including a step of applying a release agent in stripes on both sides of each ridge formed on said the other folded side of the multiplicity of stacked folded sheet pairs forming the text unit.

19. The process for producing a notebook according to claim 17, wherein the text unit comprising a multiplicity of folded sheet pairs is formed by cutting off three sides including said one folded side while leaving the other folded side of the zigzag-folded unit form group.
